(19) United States
(12) Patent Application Publication
(10) Pub. No.: US 2024/0416900 A1
(43) Pub. Date: Dec. 19, 2024

(54) APPARATUS FOR CONTROLLING AN AUTONOMOUS VEHICLE AND METHOD THEREOF

(71) Applicants: Hyundai Motor Company, Seoul (KR); Kia Corporation, Seoul (KR)

(72) Inventors: Eung Seo Kim, Gwacheon-Si (KR); Dong Hyun Sung, Hwaseong-si (KR); Yong Seok Kwon, Suwon-Si (KR); Sang Min Lee, Seoul (KR); Tae-Geun An, Yeongju-Si (KR); Hyoung Jong Wi, Seoul (KR); Joon Ho Lee, Seoul (KR); Dae Seok Jean, Hwaseong-Si (KR); Sang Yeob Lee, Seoul (KR)

(21) Appl. No.: 18/520,138

(22) Filed: Nov. 27, 2023

(30) Foreign Application Priority Data
Jun. 16, 2023 (KR) 10-2023-0077649

(51) Int. Cl. B60W 30/09; B60W 30/095; B60W 30/10; B60W 30/14; B60W 60/00

(52) U.S. Cl. CPC B60W 30/09; B60W 30/0956; B60W 30/10; B60W 30/146; B60W 60/0015; B60W 2420/403; B60W 2420/408; B60W 2554/402; B60W 2556/20

(57) ABSTRACT

The present disclosure relates to a device and a method for avoiding an obstacle. The device includes a sensor that detects an object outside a vehicle, a processor, and memory storing instructions. The device determines whether the object belongs to any pre-classified type, determines a reliability value associated with information on the object based on the object not belonging to any pre-classified type, and controls, based on the reliability value being greater than a threshold reliability value, the driving controller to avoid the object.

### CROSS-REFERENCE TO RELATED APPLICATION

This application claims the benefit of priority to Korean Patent Application No. 10-2023-0077649, filed in the Korean Intellectual Property Office on Jun. 16, 2023, the entire contents of which are incorporated herein by reference.

### TECHNICAL FIELD

The present disclosure relates to an apparatus for controlling an autonomous vehicle and method thereof, and more specifically, to a technology of controlling travel of a vehicle based on sensing an object outside the vehicle.

### BACKGROUND

An autonomous vehicle may refer to a vehicle that is able to operate on its own without manipulation of a driver or a passenger, and an automated vehicle and highway system may refer to a system that monitors and controls such an autonomous vehicle to operate on its own. In addition, technologies have been developed for monitoring the external environment (e.g., outside, surroundings) of the vehicle and operating various driving assistance features based on the monitored external environment of the vehicle.

In addition, the autonomous vehicles or vehicles equipped with the driving assistance features may detect an object by monitoring the external environment of the vehicle and are controlled based on a scenario (e.g., prediction) determined based on the detected object. In other words, a process of determining a type of object outside the vehicle may be required for autonomous driving.

The objects outside the vehicle may be classified based on predetermined classes (e.g., classifications, categories, etc.).

However, the types of objects that may be classified in advance based on the classes are limited, and unexpected obstacles that do not fit any known classification may appear on a road. When confronted with an object that has not yet been classified in advance, an autonomous vehicle may attempt to avoid the corresponding object. However, if autonomous vehicles are designed to avoid all such unclassified objects, the vehicle ride may be interfered with and thus a traffic flow may be affected even in situations where it is not necessary to avoid the object. A sudden evasive maneuver may also adversely affect safety of driving.

### SUMMARY

The present disclosure has been made to solve the above-mentioned problems occurring in the prior art while advantages achieved by the prior art are maintained intact.

An aspect of the present disclosure provides a device and a method for avoiding an obstacle that may perform autonomous driving efficiently when an object that has not been classified in advance is sensed.

Another aspect of the present disclosure provides a device and a method for avoiding an obstacle that may reduce unnecessary vehicle control caused by sensors erroneously recognizing an object when the object that has not been classified in advance is sensed.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an apparatus for controlling an autonomous vehicle may include: sensor configured to detect an object; a processor; and memory. The memory may store instructions that, when executed by the processor, cause the apparatus to: determine whether the object belongs to any pre-classified type; based on the object not belonging to any pre-classified type, determine a reliability value associated with information on the object; and control, based on the reliability value being greater than a threshold reliability value, the vehicle to avoid the object.

The sensor may include at least one of a camera, a lidar, or a radar. The instructions, when executed by the processor, may further cause the apparatus to determine the reliability value based on at least two of: a first reliability value determined based on an image acquired by the camera, a second reliability value determined based on data acquired by the lidar, or a third reliability value determined based on a reflected radio wave received by the radar.

The instructions, when executed by the processor, may further cause the apparatus to determine the first reliability value further based on a height, of the object, determined by the camera.

The instructions, when executed by the processor, may further cause the apparatus to determine the second reliability value further based on whether the object is in contact with a road surface.

The instructions, when executed by the processor, may further cause the apparatus to determine the second reliability value further based on a height of the object detected by the lidar.

The instructions, when executed by the processor, may further cause the apparatus to determine the second reliability value further based on a width of the object detected by the lidar.

The instructions, when executed by the processor, may further cause the apparatus to determine the third reliability value further based on a power of the reflected radio wave received by the radar.

The instructions, when executed by the processor, may further cause the apparatus to control the vehicle to ignore the object and maintain a current course of the vehicle based on the reliability value being less than a threshold value.

The instructions, when executed by the processor, may cause the apparatus to control the vehicle to avoid the object in a lateral direction based on a determination that the object is avoidable in the lateral direction.

The instructions, when executed by the processor, may cause the apparatus to, based on a determination that the object is unavoidable in a lateral direction, decelerate the vehicle based on the reliability value.

According to one or more example embodiments of the present disclosure, a method for controlling an autonomous vehicle may include: determining whether an object acquired by a sensor of a vehicle belongs to any pre-classified type; based on the object not belonging to any pre-classified type, determining a reliability value associated with information on the object; and controlling, based on the reliability value being greater than a threshold reliability value, the vehicle to avoid the object.

The method may further include: determining the reliability value based on at least one of: a first reliability value determined based on an image acquired by a camera of the sensor, a second reliability value determined based on data acquired by a lidar of the sensor, or a third reliability value determined based on a reflected radio wave received by a radar of the sensor.

The method may further include: determining the first reliability value further based on a height of the object determined by the camera.

The method may further include: determining the second reliability value further based on whether the object is in contact with a road surface.

The method may further include: determining the second reliability value further based on a height of the object detected by the lidar.

The method may further include: determining the second reliability value further based on a width of the object detected by the lidar.

The method may further include: determining the third reliability value further based on a power of the reflected radio wave received by the radar.

The method may further include: determining whether a second object acquired by the sensor belongs to any pre-classified type; based on the second object not belonging to any pre-classified type, determining a second reliability value associated with information on the second object; and controlling, based on the second reliability value being smaller than a threshold value, the vehicle to ignore the second object and maintain a current course of the vehicle.

Controlling the vehicle may include: controlling the vehicle to avoid the object in a lateral direction based on a determination that the object is avoidable in the lateral direction.

The method may further include: causing the vehicle to decelerate based on the reliability value.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing a configuration of an apparatus for controlling an autonomous vehicle;

FIG. 2 is a diagram showing a vehicle equipped with an apparatus for controlling an autonomous vehicle;

FIG. 3 is a schematic diagram of an artificial neural network (ANN) for reliability calculation;

FIG. 4 is a flowchart for illustrating an obstacle avoidance method;

FIGS. 5 to 7 are diagrams for illustrating an example method for determining second reliability;

FIG. 8 is a diagram for illustrating an example of determining whether to travel based on detection of a road mark disposed on a road;

FIG. 9 is a flowchart for illustrating an example obstacle avoidance method;

FIGS. 10 and 11 are diagrams for illustrating determination of a collision location;

FIG. 12 is a diagram illustrating lateral direction avoidance within a lane;

FIG. 13 is a diagram for illustrating a method for determining whether lateral direction avoidance is possible via a lane change; and

FIG. 14 shows a computing system.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example embodiments of the present disclosure, a detailed description of the related known configuration or function will be omitted when it is determined that it interferes with the understanding of the example embodiments of the present disclosure.

In describing the components of the one or more embodiments according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

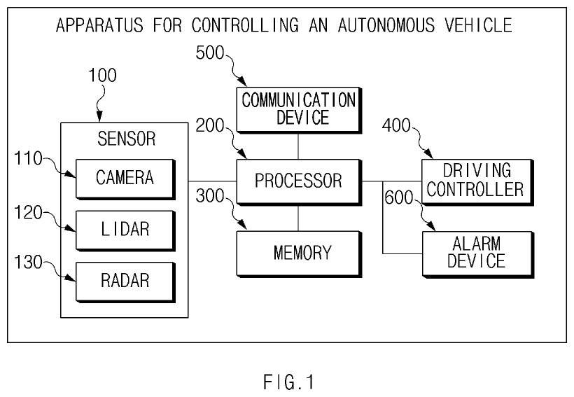

Hereinafter, the present disclosure will be described in detail with reference to FIGS. 1 to 14.

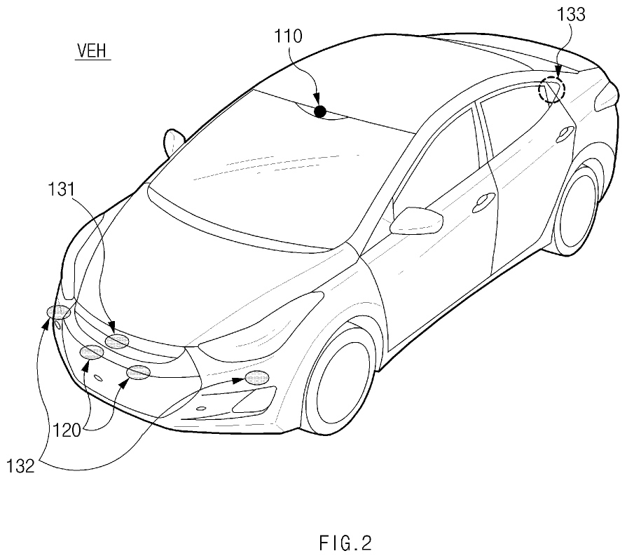

FIG. 1 is a block diagram showing a configuration of an apparatus for controlling an autonomous vehicle, and FIG. 2 is a diagram showing a vehicle equipped with an apparatus for controlling an autonomous vehicle.

Referring to FIGS. 1 and 2, the apparatus for controlling an autonomous vehicle may include a sensor 100, a processor 200, a memory 300, and a driving controller 400.

The sensor 100 may include at least one of a camera 110 for detecting an external object of a vehicle VEH, a light imaging detection and ranging (lidar) 120, or a radio detection and ranging (radar) 130.

The camera 110, which is for acquiring an external image of the vehicle VEH, may acquire an image of a front area or a front-side area of the vehicle VEH. For example, the camera 110 may be disposed around a front windshield to acquire the image of the front area of the vehicle VEH.

The lidar 120, which is for transmitting a laser and determining the object using a reflected wave (e.g., radio wave, radar signal, etc.) of the laser reflected from the object, may be implemented in a time of flight (TOF) scheme or a phase-shift scheme. The lidar 120 may be mounted to be exposed to the outside of the vehicle and may be disposed around a front bumper or a front grille.

The radar 130 may include electromagnetic wave transmission and reception modules. The radar 130 may be implemented in a pulse radar scheme or a continuous wave radar scheme in terms of a radio wave emission principle. The radar 130 may be implemented in a frequency modulated continuous wave (FMCW) scheme or a frequency shift keying (FSK) scheme based on a signal waveform among the continuous wave radar schemes. The radar 130 may include a front radar 131 located at a center of a front surface of the vehicle VEH, front-side radars 132 located at both ends of the front bumper, and a rear radar 133 located at a rear portion of the vehicle VEH.

The locations of the camera 110, the lidar 120, and the radar 130 may not be limited to what is shown in FIG. 2.

In addition to what is shown in the drawing, the sensor may include an ultrasonic sensor and an infrared sensor. The ultrasonic sensor may include ultrasonic wave transmission and reception modules. The ultrasonic sensor may detect the object based on an ultrasonic wave and may detect a location of the detected object, a distance to the detected object, and a relative speed. The ultrasonic sensor may be disposed at an appropriate location on an exterior of the vehicle to sense the object located in front of, at the rear of, or on a side of the vehicle. The infrared sensor may include infrared ray transmission and reception modules. The infrared sensor may detect the object based on the infrared ray and detect the location of the detected object, the distance to the detected object, and the relative speed. The infrared sensor may be disposed on the exterior of the vehicle to detect the object located in front of, at the rear of, or on the side of the vehicle.

In addition, the sensor 100 may further include a brake-pedal position sensor (BPS) and an accelerator position sensor (APS) that generate a speed control command for shifting the vehicle.

The brake-pedal position sensor may output a BPS signal based on a degree of depression of a brake pedal disposed in the vehicle. As an example, the BPS signal may output data from 0 to 100 based on the degree of depression of the brake pedal, the value of 0 may be a case in which the brake pedal is not pressed, and the value of 100 may be a case in which the brake pedal is pressed at the maximum.

The accelerator position sensor may output an APS signal based on a degree of depression of an accelerator pedal disposed in the vehicle. As an example, the APS signal may output data from 0 to 100 based on the degree of depression of the accelerator pedal, the value of 0 may be a case in which the accelerator pedal is not pressed, and the value of 100 may be a case in which the accelerator pedal is pressed at the maximum.

The processor 200 may determine the object outside the vehicle and perform avoidance driving based on the object.

To this end, the processor 200 may determine whether the object acquired by the sensor 100 of the vehicle VEH is an obstacle of a preset type.

The obstacle of the preset type may be an object that may be observed on a road or an object that may be classified based on a class via deep learning. For example, the obstacle of the preset type may include a vehicle, a two-wheeled vehicle, a pedestrian, a traffic facility, and the like.

The processor 200 may determine (e.g., calculate) reliability (e.g., a reliability value) when the object is not the obstacle. The reliability may be for providing a criterion for determining information on the object.

The processor 200 may acquire final reliability based on at least one of first reliability determined by the camera 110, second reliability determined by the lidar 120, or third reliability determined by the radar 130.

The processor 200 may determine the object as the obstacle, which is an avoidance target, based on the reliability being equal to or greater than a preset threshold value. For example, the processor 200 may determine the object as the obstacle based on the final reliability being equal to or greater than the threshold value.

In addition, the processor 200 may ignore the object and maintain a travel route based on the final reliability being less than the threshold value.

The processor 200 may control travel of the vehicle to avoid the obstacle based on the detection of the obstacle.

The processor 200 may control a steering controller to avoid the obstacle based on determining that the obstacle may be avoided in a lateral direction.

The processor 200 may decelerate the vehicle by controlling a braking controller when the obstacle is not able to be avoided in the lateral direction. The processor 200 may decelerate the vehicle by setting a braking amount based on (e.g., proportional to) a value of the final reliability.

In addition, the processor 200 may perform artificial intelligence learning on data provided from the sensor 100 to detect a target vehicle and a dangerous vehicle. To this end, the processor 200 may include an artificial intelligence (hereinafter, referred to as AI) processor. The AI processor may learn a neural network using a pre-stored program. The neural network for detecting the target vehicle and the dangerous vehicle may be designed to simulate a human brain structure on a computer, and may include a plurality of network nodes having weights that simulate neurons of a human neural network. The plurality of network nodes may transmit and receive data based on connection relationships therebetween so as to simulate synaptic activity of the neurons that transmit and receive signals via synapses. The neural network may include a deep learning model developed from a neural network model. In the deep learning model, the plurality of network nodes may transmit and receive the data based on convolution connection relationships while being located in different layers. Examples of the neural network models may include various deep learning techniques such as a deep neural network (DNN), a convolutional deep neural network (CNN), a recurrent Boltzmann machine (RNN), a restricted Boltzmann machine (RBM), a deep belief network (DBN), and a deep Q-network.

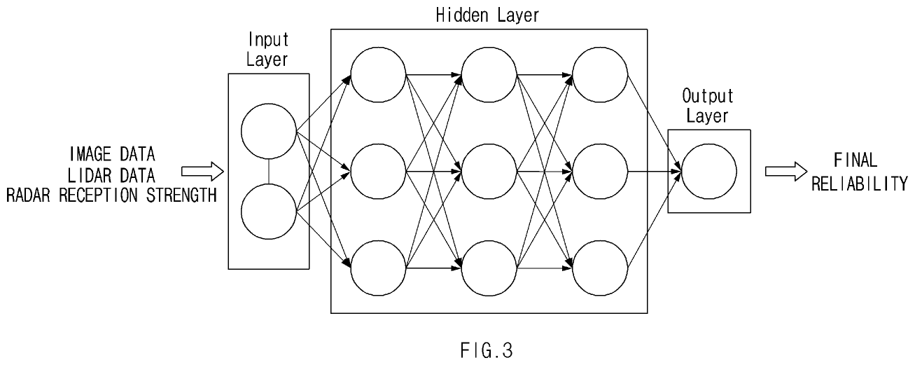

FIG. 3 is a schematic diagram of an artificial neural network (ANN) for reliability calculation.

Referring to FIG. 3, the processor 200 may determine (e.g., calculate) the final reliability (e.g., reliability value, reliability score, etc.) using the artificial neural network shown in FIG. 3.

The artificial neural network may be stored in the processor 200 or the memory. The artificial neural network mathematically models a connected form of the human neurons, and is able to include an input layer, a hidden layer, and an output layer.

The input layer may multiply input data by a weight matrix and provide the result to a hidden layer. The input data may be variables used to determine (e.g., calculate) the reliability. For example, the input data may include the image acquired by the camera 110, data acquired by the lidar 120, a reception strength of the radar 130, and the like.

The hidden layer may process the input data based on an activation function. In addition, the hidden layer may multiply the processed input data by a new weight matrix and transmit the result to the output layer.

The output layer may output a result by reflecting an activation function for output. The output layer may output the final reliability as an output value.

In addition, the processor 200 may determine whether to avoid the obstacle based on the information on the object on a road surface provided from another vehicle via a communication device 500.

The memory 300 may store algorithms and the AI processor for the operation of the processor 200. The memory 300 may use a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), a dynamic random access memory (DRAM), a synchronous dynamic random access memory (SDRAM), a double date rate-SDRAM (DDR-SDRAM), and the like.

The driving controller 400, which is for controlling steering and the deceleration and acceleration of the vehicle in response to a control signal from the processor 200, may include the steering controller, an engine controller, the braking controller, and a transmission control module.

The steering controller may be classified into a hydraulic power steering (HPS) system that controls the steering using a hydraulic pressure formed by a hydraulic pump and a motor driven power steering (hereinafter, ‘MDPS’) system that controls the steering using an output torque of an electric motor.

The engine controller is an actuator that controls an engine of the vehicle and controls the acceleration of the vehicle. The engine controller may be implemented as an engine management system (EMS). The engine controller controls a driving torque of the engine based on accelerator pedal position information output from the accelerator position sensor. The engine controller controls output of the engine to follow a travel speed of the vehicle requested by the processor 200 during autonomous driving.

The braking controller is an actuator that controls the deceleration of the vehicle, and is able to be implemented as an electronic stability control (ESC). The braking controller controls a braking pressure to follow a target speed requested from the processor 200. That is, the braking controller controls the deceleration of the vehicle.

The transmission control module is an actuator for controlling a transmission of the vehicle and is able to be implemented as a shift by wire (SBW). The transmission control module controls the shift of the vehicle based on a gear position and a gear state range.

In addition, the apparatus for controlling an autonomous vehicle may further include the communication device 500 and an alarm device 600.

The communication device 500 may communicate with a user terminal, another vehicle, or an external server.

The communication device 500 may support short-range communication using at least one of Bluetooth, radio frequency identification (RFID), infrared data association (IrDA), ultra wideband (UWB), ZigBee, near field communication (NFC), wireless-fidelity (Wi-Fi), Wi-Fi Direct, and wireless universal serial bus (wireless USB) technologies.

The communication device 500 may include a global positioning system (GPS) module or a differential global positioning system (DGPS) module for obtaining location information.

In addition, the communication device 500 may include a V2X communication module. The V2X communication module may include an RF circuit for a protocol for wireless communication with a server (vehicle to infra; V2I), another vehicle (vehicle to vehicle; V2V), or the pedestrian (vehicle to pedestrian; V2P). The communication device 500 may receive sensing data acquired by a sensor of another vehicle and provide the data to the processor 200 via the V2X communication module.

The alarm device 600 may notify an occupant of the vehicle of the obstacle determined by the processor 200, and may notify an emergency braking or an avoidance situation caused by the obstacle. The alarm device 600 may include a display, a speaker, and the like.

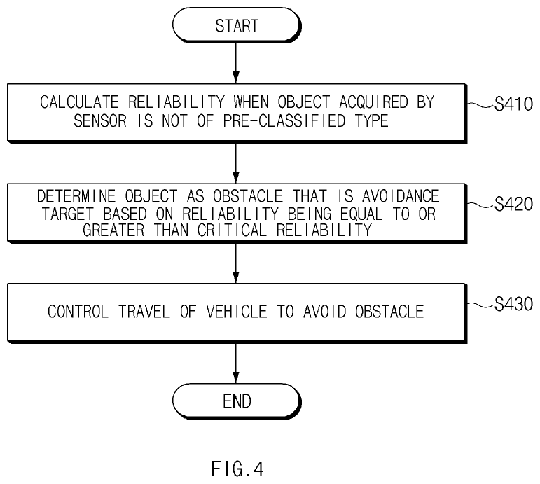

FIG. 4 is a flowchart for illustrating an obstacle avoidance method. FIG. 4 may be a procedure controlled by the processor shown in FIG. 1.

Referring to FIGS. 1 to 4, the obstacle avoidance method will be described as follows.

In S410, the processor 200 may determine (e.g., calculate) the reliability when the object acquired by the sensor 100 is not of a pre-classified type (e.g., a known classification).

For example, the processor 200 may learn the image acquired by the camera 110 using a semantic segmentation scheme and classify objects contained in the image. The object classification may be performed via preset classes. When an object of a class other than the preset classes is detected in the image, the processor 200 may determine (e.g., calculate) the reliability.

A process of determining (e.g., calculating) the reliability may include a process of determining (e.g., calculating) the first reliability determined by the image acquired by the camera 110. For example, the processor 200 may set the first reliability smaller as a height of an unclassified object among objects detected in the image is smaller.

The process of determining (e.g., calculating) the reliability may include a process of determining (e.g., calculating) the second reliability determined by the data acquired by the lidar 120. For example, the processor 200 may determine a value of the second reliability of the object in contact with a road surface to be greater than the second reliability of the object not in contact with the road surface. In addition, the processor 200 may set the second reliability greater as a height of the object detected by the lidar 120 is greater. In addition, the processor 200 may set the second reliability greater as a width of the object detected by the lidar 120 is greater.

The process of determining (e.g., calculating) the reliability may include a process of determining (e.g., calculating) the third reliability determined by power of a reflected wave of the radar 130. The processor 200 may receive the power of the reflected wave received by the radar 130 and may set the third reliability based on (e.g., proportional to) the power of the reflected wave.

The processor 200 may determine (e.g., calculate) the final reliability using at least one of the first reliability, the second reliability, or the third reliability. Each of the first reliability, the second reliability, and the third reliability may be the final reliability. In addition, to more accurately determine information on the object, the processor 200 may calculate the final reliability by selecting at least two among the first reliability, the second reliability, and the third reliability.

In S420, the processor 200 may determine the object as the obstacle that is the avoidance target based on the reliability being equal to or greater than threshold reliability.

The processor 200 may compare the final reliability with the threshold reliability, and the threshold reliability may be preset.

In S430, the processor 200 may control the travel of the vehicle to avoid the obstacle.

To this end, the processor 200 may control the driving controller 400 to decelerate the vehicle or control the steering of the vehicle.

Hereinafter, each procedure will be described as follows.

Table 1 is a table showing an example of determining the first reliability.

TABLE 1

| Magnitude of height of object | First reliability CV1 |
|---|---|
| Object height H_I > Hth1 | 60 |
| Object height H_I ≤ Hth1 | 20 |

Referring to Table 1, the processor 200 may determine first reliability CV1 to be “60” based on an image-based object height H_I exceeding a preset first threshold value Hth1. The first threshold value Hth1 may be determined to be a height of a level at which the vehicle VEH may travel ignoring the object.

The image-based object height H_I may mean the height of the object calculated based on the image acquired by the camera 110. The image acquired by the camera 110 may be expressed in an image coordinate system. The image coordinate system may be a coordinate system in which a top left pixel of the image is an origin (0,0), a horizontal location of a pixel in the image is expressed as a ‘u’ coordinate component, and a vertical location of the pixel is expressed as a ‘v’ coordinate component.

In the image coordinate system, the ‘u’ coordinate component may be an x-axis direction of a world coordinate system, and the ‘v’ coordinate component may be a y-axis direction of the world coordinate system. Assuming that the road surface is flat, an x-axis and a y-axis may refer to linear axes that determine a plane parallel to the road surface, the y-axis direction may mean a forward direction of the vehicle, and the x-axis may mean the lateral direction of the vehicle perpendicular to the y-axis. In the world coordinate system, a z-axis direction may mean a height with respect to the road surface.

The processor 200 may acquire the actual height of the object based on image coordinates of the object detected from the image. Any known technology may be used as a method for the processor 200 to acquire the actual height of the object.

In addition, referring to Table 1, the processor 200 may determine the first reliability CV1 to be “20” based on the image-based object height H_I being less than or equal to the first threshold value Hth1.

Table 2 is a table showing an example of determining the second reliability.

TABLE 2

| Magnitudes of height/width, and height | Second reliability |
|---|---|
| offset of object | CV2 |
| Height_offset = 1 | 10 |
| Height_offset = 0, H_L ≤ Hth2 | 20 |
| Height_offset = 0, H_L > Hth2, Wd > Hth3 | 80 |

Referring to Table 2, the processor 200 may determine second reliability CV2 based on the lidar-based object height, the lidar-based object width, a height offset, and the like.

Sensing data of the lidar for determining the second reliability will be described as follows.

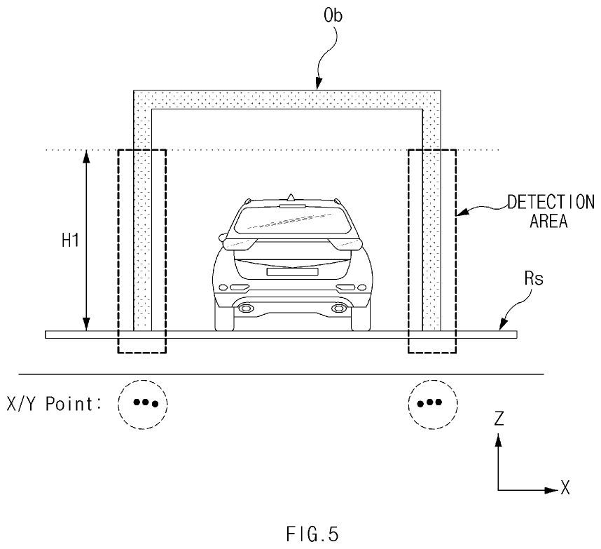

FIGS. 5 to 7 are diagrams for illustrating an example method for determining second reliability.

Referring to FIGS. 5 to 7, the processor 200 may acquire x/y data where an object Ob is located on an xy plane, and the height and the height offset of the object may be determined based on an area where the x/y data is located.

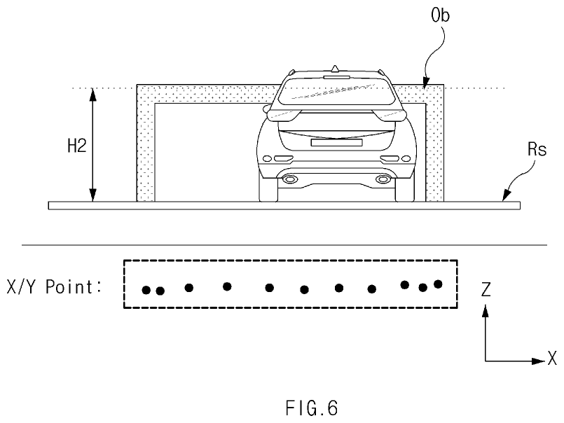

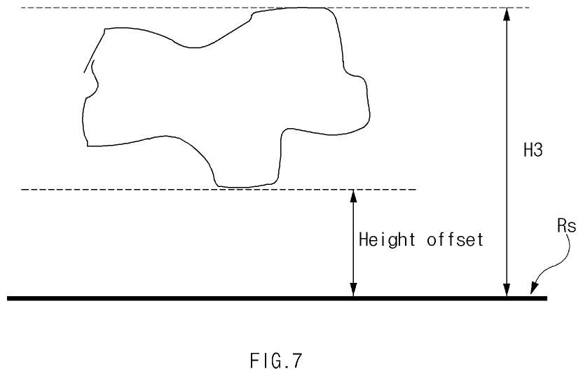

The processor 200 may determine a distance from a road surface Rs to an uppermost point of the object Ob as a height of the object Ob. For example, as shown in FIG. 5, when the object Ob is located close to the vehicle VEH and is large, an upper area of the object Ob may not be detected by the lidar 120. Therefore, a height of the object Ob shown in FIG. 5 may be estimated to be “H1”. Alternatively, a height of the object Ob shown in FIG. 6 may be determined to be “H2”, and a height of the object Ob shown in FIG. 7 may be determined to be “H3”.

The height offset may mean a factor indicating whether the object Ob is in contact with the road surface Rs. When the object Ob is in contact with the road surface Rs, the height offset may be set to “0”, and when the object Ob is not in contact with the road surface Rs, the height offset may be set to “1”. Therefore, all of height offsets of the object Ob detected by the lidar 120 in FIG. 5 may be set to “0”. Accordingly, height offsets of the object Ob shown in FIG. 5 and the object Ob shown in FIG. 6 may be set to “0”. In addition, a height offset of the object Ob shown in FIG. 7 may be set to “1”.

The processor 200 may determine the second reliability CV2 to be “10” when the height offset is “1”.

In addition, the processor 200 may determine the second reliability CV2 to be “20” when the height offset is “0” and the height of the object is less than or equal to a preset second threshold value Hth2.

In addition, when the height offset is “0”, the height of the object exceeds the preset second threshold value Hth2, and the width of the object exceeds a preset third threshold value Hth3, the processor 200 may determine the second reliability CV2 to be “80”.

Table 3 is a table showing an example of determining the third reliability.

TABLE 3

| | Third reliability |
|---|---|
| Value of power of reflected wave | CV3 |
| Power > Pth1 | 40 |
| Pth1 ≥ Power > Pth2 | 20 |
| Pth2 ≥ Power | 0 |

Referring to Table 3, the processor 200 may determine third reliability CV3 based on the power of the reflected wave of the radar.

When the power of the reflected wave of the radar exceeds first critical power Pth1, the processor 200 may determine the third reliability CV3 to be “40”.

When the power of the reflected wave of the radar is less than or equal to the first critical power Pth1 and exceeds second critical power Pth2, the processor 200 may determine the third reliability CV3 to be “20”.

When the power of the reflected wave of the radar is less than or equal to the second critical power Pth2, the processor 200 may determine the third reliability CV3 to be “0 (zero)”.

The first critical power Pth1 may be set greater than the second critical power Pth2.

The processor 200 may determine final reliability CV_f based on the first reliability CV1, the second reliability CV2, and the third reliability CV3. The processor 200 may determine the final reliability CV_f as shown in Equation 1 below.

$$CV\_f = a 1 \times CV 1 + b 1 \times CV 2 + c 1 \times CV 3 \qquad \text{<Equation 1>}$$

The final reliability CV_f may be determined by Equation 1, and a scheme of determining the final reliability CV_f may be performed in various ways. In 1, al, b1, and cl are variables used in the process of determining the final reliability CV_f and may be adjusted by the designer.

Table 4 is a table illustrating a method for determining whether normal driving is possible and an amount of deceleration based on the final reliability CV_f.

TABLE 4

| Final reliability | Maximum braking | | Whether normal |
|---|---|---|---|
| CV_f | control amount | | driving is possible |
| CVth1 > CV_f | Uncontrolled | | Drivable |
| CVth2 > CV_f ≥ | −4 | m/s² | Not drivable |
| CVth1 | | | |
| CVth3 > CV_f ≥ | −6 | m/s² | Not drivable |
| CVth2 | | | |
| CV_f ≥ CVth3 | −9.8 | m/s² | Not drivable |

Referring to Table 4, when the final reliability CV_f is equal to or greater than first threshold reliability CVth1, the processor 200 may determine that the normal driving is impossible. The normal driving may refer to a state in which the travel is maintained while maintaining the speed of the vehicle in motion without a lane change.

When the final reliability CV_f is equal to or greater than the first threshold reliability CVth1, the processor 200 may determine a maximum braking control amount for reducing the speed of the vehicle, and a value of the maximum braking control amount may be proportional to a value of the final reliability.

For example, when the final reliability CV_f is equal to or greater than the first threshold reliability CVth1 and less than second threshold reliability CVth2, the processor 200 may determine the maximum braking control amount to be “−4 m/s2”.

In addition, when the final reliability CV_f is equal to or greater than the second threshold reliability CVth2 and less than third threshold reliability CVth3, the processor 200 may determine the maximum braking control amount to be “−6 m/s2”.

In addition, when the final reliability CV_f is equal to or greater than the third threshold reliability CVth3, the processor 200 may determine the maximum braking control amount to be “−9.8 m/s2”.

The maximum braking control amount shown in Table 4, and the value of the maximum braking control amount is able to be set to a different value.

In addition, when the final reliability CV_f is less than the first threshold reliability CVth1, the processor 200 may ignore the object acquired by the sensor 100 and maintain the traveling state.

The first threshold reliability CVth1 may be preset to be “50”, the second threshold reliability CVth2 may be preset to be “70”, and the third threshold reliability CVth3 may be preset to be “80”, but values of the threshold reliability CVth1, CVth2, and CVth3 may not be limited thereto.

An example of determining whether the normal driving is possible based on the final reliability CV_f will be described as follows.

As shown in FIG. 7, an example of determining whether the normal driving is possible for the object not in contact with the road surface will be described as follows.

As shown in FIG. 7, when the object Ob is floating in the air without being in contact with the road surface, the processor 200 may determine the second reliability CV2 to be “10” based on Table 2.

When the object Ob is light, the power of the reflected wave may be identified to be weak, and the processor 200 may determine the third reliability CV3 to be “0” based on Table 3. Therefore, when the object floating above the road surface is the light object, the final reliability CV_f may be determined to be “10”. When the first threshold reliability CVth1 is “50”, the processor 200 may maintain the normal driving based on the final reliability CV_f being determined to be 10.

Alternatively, when the object Ob is heavy, the power of the reflected wave may be identified to be great, and the processor 200 may determine the third reliability CV3 to be “40” based on Table 3. Therefore, when the object floating above the road surface is the heavy object, the final reliability CV_f may be determined to be “50”. When the first threshold reliability CVth1 is “50”, the processor 200 may control the driving controller 400 to decelerate the vehicle or perform the avoidance driving based on the final reliability CV_f being determined to be 50.

A value of the threshold reliability may be an example and may vary based on design.

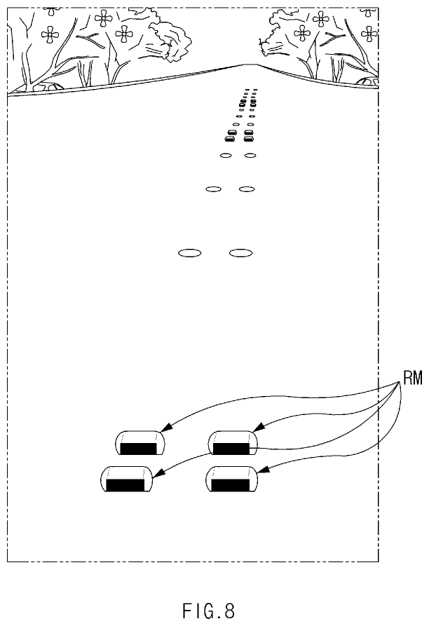

Referring to FIG. 8, an example of determining whether to perform normal driving when a small structure is detected will be described as follows.

FIG. 8 is a diagram for illustrating an example of determining whether to travel based on detection of a road mark disposed on a road.

As shown in FIG. 8, because a road mark RM in a form of a botts dot protrudes not high from the road surface, the road mark RM may not have a great influence on the travel of the vehicle. However, because of characteristics of the structure, a light reflectance is great, so that the road mark RM may be recognized as a large object by the lidar 120 or the radar 130.

Because the small road mark RM determined by the camera 110 has the small height, the processor 200 may determine the first reliability CV1 to be “20” based on Table 1. In addition, the processor 200 may determine the second reliability CV2 to be “20” based on Table 2. As a result, the final reliability CV_f may be determined to be “40”, and the processor 200 may maintain the normal driving state based on Table 4.

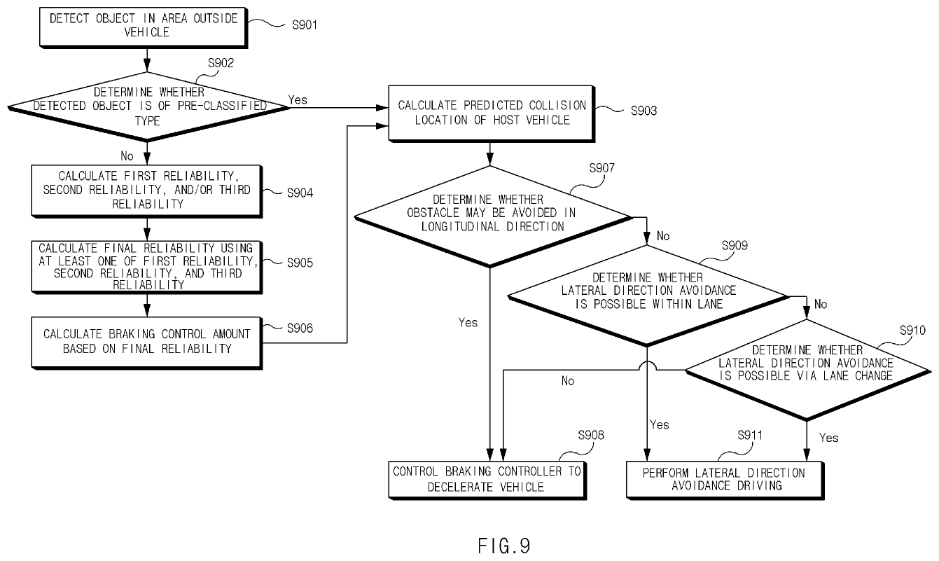

FIG. 9 is a flowchart for illustrating an example obstacle avoidance method. FIG. 9 may be a procedure controlled by the processor shown in FIG. 1.

Referring to FIG. 9, an example obstacle avoidance method will be described as follows.

In S901, the processor 200 may detect the object in the area outside the vehicle based on the sensing data acquired by the sensor 100.

In S902, the processor 200 may determine whether the detected object is of the pre-classified type. The object of the pre-classified type may mean the object that may be classified based on the class via the machine learning (e.g., deep learning).

In S903, when the detected object is of the pre-classified type, the processor 200 may determine (e.g., calculate) a predicted collision location of a host vehicle.

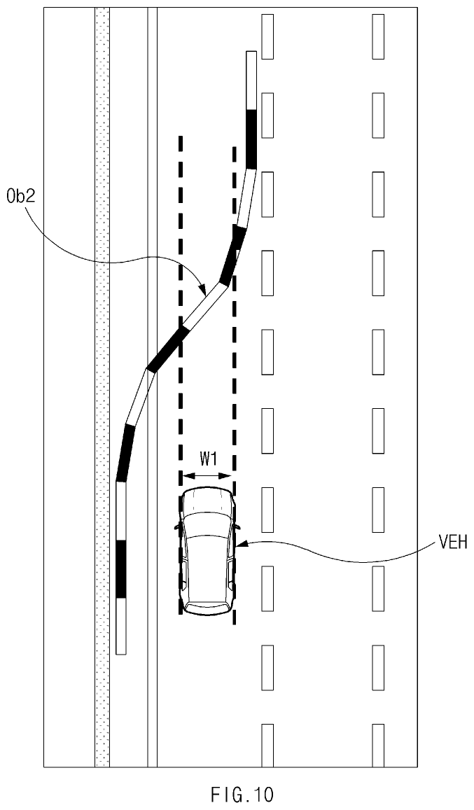

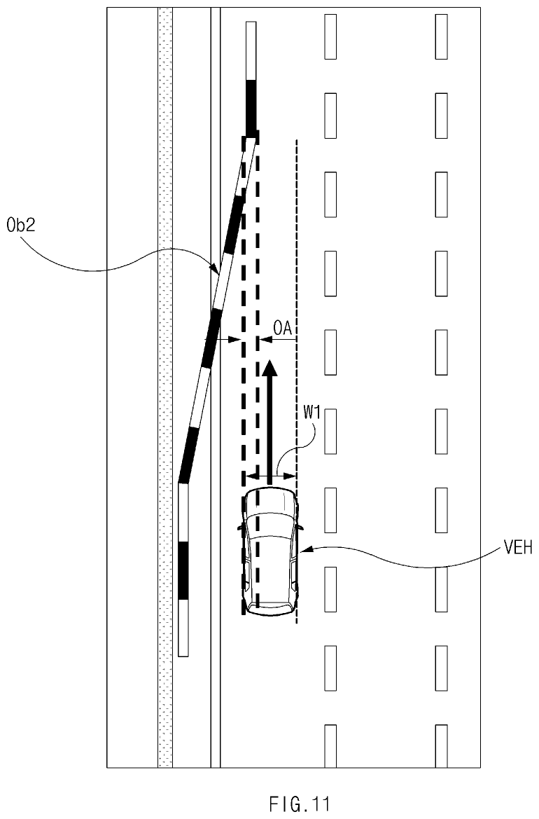

A method for determining (e.g., calculating) a collision location will be described as follows with reference to FIGS. 10 and 11.

FIGS. 10 and 11 are diagrams for illustrating determination of a collision location.

As shown in FIGS. 10 and 11, the processor 200 may calculate the collision location based on a degree of overlap between an obstacle Ob2 and the vehicle VEH.

The processor 200 may calculate a ratio of an overlap area OA between the vehicle VEH and the obstacle Ob2 with respect to a width of the vehicle VEH on the x-axis as the degree of overlap. For example, as shown in FIG. 10, when the overlap area OA between a vehicle width W1 and the obstacle Ob2 on the x-axis is equal to or greater than the vehicle width W1, the processor 200 may calculate the overlap to be 100(%). Alternatively, as shown in FIG. 11, when the overlap area OA where the vehicle width W1 and the obstacle Ob2 overlap on the x-axis corresponds to ⅕ of the vehicle width W1, the processor 200 may calculate the overlap to be 20(%).

In S904, when the detected object is not of the pre-classified type, the processor 200 may calculate the first reliability, the second reliability, and/or the third reliability.

For example, the processor 200 may calculate the first reliability using Table 1 based on the image acquired by the camera 110. In addition, the processor 200 may calculate the second reliability using Table 2 based on the data acquired by the lidar 120. In addition, the processor 200 may calculate the third reliability using Table 3 based on the data acquired by the radar 130.

In S905, the processor 200 may calculate the final reliability using at least one of the first reliability, the second reliability, and the third reliability. The processor 200 may determine (e.g., calculate) the final reliability using at least two among the first reliability, the second reliability, and the third reliability.

In S906, the processor 200 may calculate a braking control amount based on the final reliability.

The processor 200 may set a value of the braking control amount based on (e.g., proportional to) the value of the final reliability, as shown in Table 4.

Based on the predicted collision location calculated in S903, the processor 200 may determine whether the obstacle may be avoided in a longitudinal direction in S907.

When a collision with the obstacle may be avoided via the deceleration without controlling the steering controller, the processor 200 may determine that the obstacle may be avoided in the longitudinal direction.

To determine whether the obstacle may be avoided in the longitudinal direction, the processor 200 may identify the distance to the obstacle, the travel speed of the vehicle, and the braking control amount of the vehicle.

In S908, when it is determined that the obstacle may be avoided in the longitudinal direction, the processor 200 may control the braking controller to decelerate the vehicle.

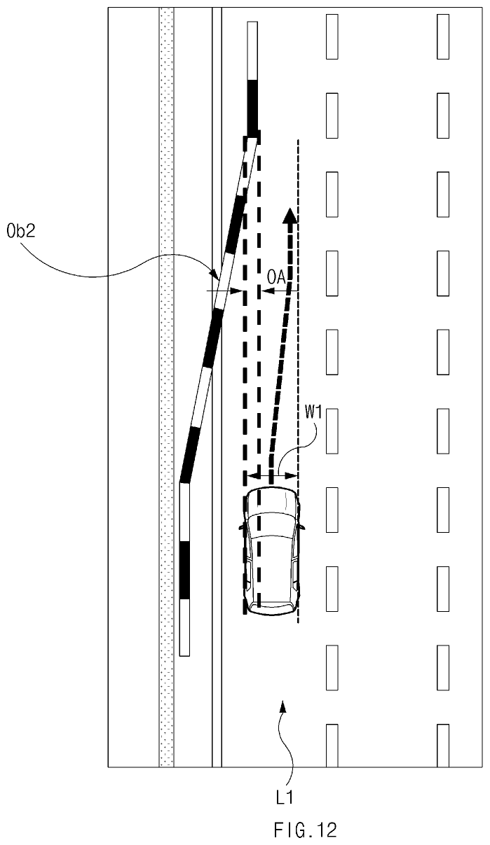

In S909, when it is determined that the longitudinal collision avoidance is impossible, the processor 200 may determine whether lateral direction avoidance is possible within a lane. Operation S909 will be described with reference to FIG. 12 as follows.

FIG. 12 is a diagram illustrating lateral direction avoidance within a lane.

The processor 200 may determine an avoidance route of the vehicle VEH to avoid the overlap area OA of the vehicle VEH and the obstacle Ob2. Even when the overlap area OA is avoided, when a free space in which the vehicle VEH may travel is secured within a lane L1, the processor 200 may determine that the obstacle Ob2 may be avoided in the lateral direction within the lane L1 without the lane change.

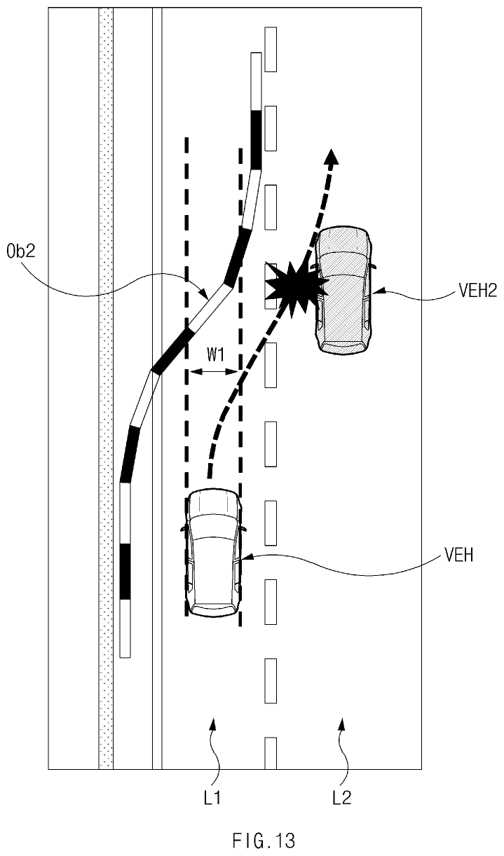

In S910, when the lateral direction avoidance is impossible within the lane, the processor 200 may determine whether the lateral direction avoidance is possible via the lane change. Operation S910 will be described with reference to FIG. 13 as follows.

FIG. 13 is a diagram for illustrating a method for determining whether lateral direction avoidance is possible via a lane change.

The processor 200 may determine the avoidance route of the vehicle VEH to avoid the overlap area OA of the vehicle VEH and the obstacle Ob2. When the overlap area OA is not able to be avoided within the lane L1, the vehicle may plan the lane change to an adjacent lane L2. As shown in FIG. 13, when there is only one adjacent lane L2 and a collision with another vehicle VEH2 in the adjacent lane L2 is expected when the vehicle VEH, which is the host vehicle, changes the lane, the processor 200 may determine that the obstacle Ob2 is not able to be avoided via the lane change.

When it is determined in operations S909 and S910 that the obstacle Ob2 may be avoided in the lateral direction, the processor 200 may perform the lateral direction avoidance driving by controlling the steering controller in operation S911.

In addition, when it is determined in S910 that the lateral direction avoidance is impossible, the processor 200 may perform longitudinal direction control via braking. In S910, the case in which the lateral direction avoidance is impossible may be a situation in which the obstacle Ob2 is not able to be avoided in the longitudinal direction and the lateral direction. When the avoidance of the obstacle Ob2 is impossible and another vehicle is traveling in the adjacent lane, the processor 200 may decelerate the vehicle while selecting the collision with the obstacle Ob2.

When entering operation S908 after operation S910, the processor 200 may brake the vehicle with the maximum braking amount of the vehicle regardless of the final reliability.

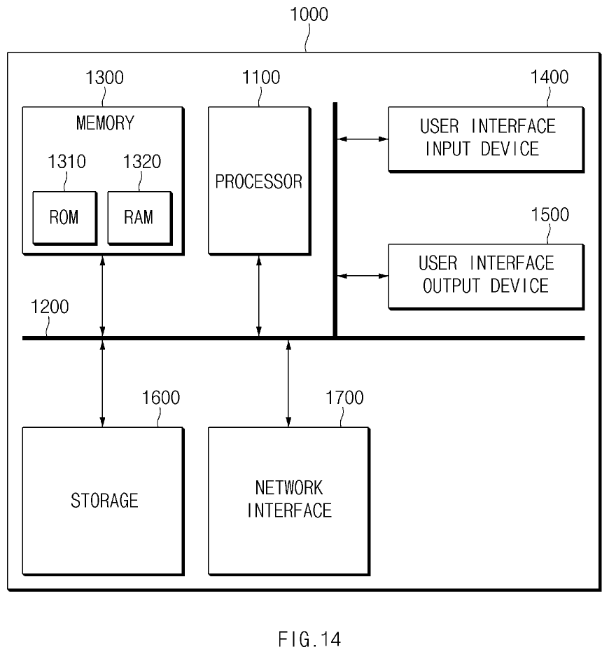

FIG. 14 shows a computing system.

Referring to FIG. 14, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described as disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the one or more example embodiments disclosed in the present disclosure are not intended to limit the technical idea of the present disclosure but to illustrate the present disclosure, and the scope of the technical idea of the present disclosure is not limited by the example embodiments. The scope of the present disclosure should be construed as being covered by the scope of the appended claims, and all technical ideas falling within the scope of the claims should be construed as being included in the scope of the present disclosure.

Even when the object that has not been classified in advance is sensed, the information on the object may be more accurately identified based on characteristics of the sensors to reduce the unnecessary vehicle control.

In addition, When a specific sensor erroneously recognizes the object depending on the object, reliability of information recognized by the corresponding sensor may be set low to more accurately determine the object and control the vehicle based on the reliability.

In addition, various effects identified directly or indirectly via the present document may be provided.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling an autonomous vehicle, the apparatus comprising:
a sensor configured to detect an object;
a processor; and
memory storing instructions that, when executed by the processor, cause the apparatus to:
determine whether the object belongs to any pre-classified type;
based on the object not belonging to any pre-classified type, determine a reliability value associated with information on the object; and
control, based on the reliability value being greater than a threshold reliability value, a vehicle to avoid the object.

2. The apparatus of claim 1, wherein the sensor comprises at least one of a camera, a lidar, or a radar,
wherein the instructions, when executed by the processor, further cause the apparatus to determine the reliability value based on at least two of: a first reliability value determined based on an image acquired by the camera, a second reliability value determined based on data acquired by the lidar, or a third reliability value determined based on a reflected radio wave received by the radar.

3. The apparatus of claim 2, wherein the instructions, when executed by the processor, further cause the apparatus to determine the first reliability value further based on a height, of the object, determined by the camera.

4. The apparatus of claim 2, wherein the instructions, when executed by the processor, further cause the apparatus to determine the second reliability value further based on whether the object is in contact with a road surface.

5. The apparatus of claim 2, wherein the instructions, when executed by the processor, further cause the apparatus to determine the second reliability value further based on a height of the object detected by the lidar.

6. The apparatus of claim 2, wherein the instructions, when executed by the processor, further cause the apparatus to determine the second reliability value further based on a width of the object detected by the lidar.

7. The apparatus of claim 2, wherein the instructions, when executed by the processor, further cause the apparatus to determine the third reliability value further based on a power of the reflected radio wave received by the radar.

8. The apparatus of claim 2, wherein the instructions, when executed by the processor, further cause the apparatus to control the vehicle to ignore the object and maintain a current course of the vehicle based on the reliability value being less than a threshold value.

9. The apparatus of claim 1, wherein the instructions, when executed by the processor, cause the apparatus to control the vehicle to avoid the object in a lateral direction based on a determination that the object is avoidable in the lateral direction.

10. The apparatus of claim 1, wherein the instructions, when executed by the processor, cause the apparatus to, based on a determination that the object is unavoidable in a lateral direction, decelerate the vehicle based on the reliability value.

11. A method for controlling an autonomous vehicle, the method comprising:
determining whether an object acquired by a sensor of a vehicle belongs to any pre-classified type;
based on the object not belonging to any pre-classified type, determining a reliability value associated with information on the object; and
controlling, based on the reliability value being greater than a threshold reliability value, the vehicle to avoid the object.

12. The method of claim 11, further comprising:
determining the reliability value based on at least one of: a first reliability value determined based on an image acquired by a camera of the sensor, a second reliability value determined based on data acquired by a lidar of the sensor, or a third reliability value determined based on a reflected radio wave received by a radar of the sensor.

13. The method of claim 12, further comprising:
determining the first reliability value further based on a height of the object determined by the camera.

14. The method of claim 12, further comprising:
determining the second reliability value further based on whether the object is in contact with a road surface.

15. The method of claim 12, further comprising:
determining the second reliability value further based on a height of the object detected by the lidar.

16. The method of claim 12, further comprising:
determining the second reliability value further based on a width of the object detected by the lidar.

17. The method of claim 12, further comprising:
determining the third reliability value further based on a power of the reflected radio wave received by the radar.

18. The method of claim 11, further comprising:
determining whether a second object acquired by the sensor belongs to any pre-classified type;
based on the second object not belonging to any pre-classified type, determining a second reliability value associated with information on the second object; and
controlling, based on the second reliability value being smaller than a threshold value, the vehicle to ignore the second object and maintain a current course of the vehicle.

19. The method of claim 11, wherein the controlling of the vehicle comprises:
controlling the vehicle to avoid the object in a lateral direction based on a determination that the object is avoidable in the lateral direction.

20. The method of claim 11, further comprising:
causing the vehicle to decelerate based on the reliability value.
